(19) United States
(12) Patent Application Publication
(10) Pub. No.: US 2017/0276470 A1
(43) Pub. Date: Sep. 28, 2017

(54) OPTICAL FREQUENCY DOMAIN REFLECTOMETER AND OPTICAL FREQUENCY DOMAIN REFLECTOMETRY

(71) Applicant: ANRITSU CORPORATION, Kanagawa (JP)

(72) Inventor: Takashi Mori, Kanagawa (JP)

(21) Appl. No.: 15/467,200

(22) Filed: Mar. 23, 2017

(30) Foreign Application Priority Data
Mar. 28, 2016 (JP) 2016-064715

(51) Int. Cl. G01B 9/02

(52) U.S. Cl. CPC G01B 9/0209; G01B 9/02083

(57) ABSTRACT

An optical frequency domain reflectometer according to the invention includes: a swept light source that outputs wavelength-swept light;
an auxiliary interferometer that has a the auxiliary interference signal generating delay fiber and outputs an auxiliary interference signal from the wavelength-swept light;
a measurement interferometer that has a measurement target optical fiber and outputs a measurement interference signal from the wavelength-swept light;
a plurality of linearization units that have different delay times, compensate non-linearity in a wavelength sweep of the swept light source for the measurement interference signal, using the auxiliary interference signal, and output compensated signals as output signals; and
a weighted addition and Fourier transform unit that outputs a frequency domain signal as a result of addition and Fourier transformation of weighted signals which are multiplying the output signals from the plurality of linearization units by different weights.

### TECHNICAL FIELD

The present invention relates to an optical frequency domain reflectometry and an optical frequency domain reflectometer that measure the strain or temperature distribution of a measurement target optical fiber, using a wavelength-swept light source, and more particularly, to a method for correcting an error that occurs in a case in which the optical frequency sweep characteristics of a wavelength-swept light source are not linear.

### BACKGROUND ART

A basic structure will be described below. In the related art, the strain or temperature of an optical fiber is measured by optical frequency domain reflectometry (OFDR). FIG. 1A illustrates the basic structure of the optical frequency domain reflectometry according to the related art.

A swept light source 1 outputs wavelength-swept light such that an optical frequency varies linearly with respect to time. A measurement interferometer 4 splits input light into two light components and inputs one of the two light components to a measurement target optical fiber. Then, the measurement interferometer 4 combines light reflected from the measurement target optical fiber and the other light component (reference light) and outputs the combined light. For example, as illustrated in FIG. 1B, an optical coupler 41a splits input light into two light components and inputs one of the two light components to a first terminal of an optical circulator 42a. The light input to the first terminal of the optical circulator 42a is output from a second terminal and is input to a measurement target optical fiber 43a.

Light reflected from the measurement target optical fiber 43a is input to the second terminal of the optical circulator 42a and is output from a third terminal. An optical coupler 45a combines the light output from the third terminal of the optical circulator 42a and the other light component (reference light) split by the optical coupler 41a and outputs the combined light.

Light output from the measurement interferometer 4 is input to a photodetector 11 and is converted into an electric signal that is proportional to light intensity. Here, a beat generated by the interference between light reflected from the measurement target optical fiber 43a and the reference light is output as an electric signal. An A/D converter 12 converts the electric signal output from the photodetector into a digital signal and a Fourier transform unit 60 performs Fourier transform for the digital signal.

As illustrated in FIG. 2A, it is assumed that three reflection points on the measurement target optical fiber 43a are points a, b, and c and the distances between the points a, b, and c and a near end point o of the measurement target optical fiber 43a are Lₐ, L_{b}, and L_{c}, respectively. When the travel distance of light that is output from the optical coupler 41a, is reflected from the near end point o of the measurement target optical fiber 43a, and is input to the optical coupler 45a is equal to the travel distance of the reference light from the optical coupler 41a to the optical coupler 45a, light that is reflected at the point a of the measurement target optical fiber 43a has a time lag of tₐ=2nLₐ/c with respect to the reference light and the reflected light and the reference light are combined by the optical coupler 45a.

Here, n is the refractive index of the measurement target optical fiber 43a and c is the speed of light. Similarly, light components reflected at the points b and c have a time lag of t_{b}=2nL_{b}/c and a time lag of t_{c}=2nL_{c}/c. The optical frequency vᵣ of the reference light, the optical frequency vₐ of light reflected from the point a, the optical frequency v_{b} of light reflected from the point b, and the optical frequency v_{c} of light reflected from the point c are as illustrated in FIG. 2B. When a variation in the optical frequency of output light from the swept light source 1 per unit time is S, a beat frequency fₐ generated by the interference between the light reflected from the point a and the reference light is represented by Equation 1. Similarly, beat frequencies f_{b} and f_{c} generated by the interference between the light components reflected from the points b and c and the reference light are represented by Equations 2 and 3, respectively.

$$\begin{matrix}{f}_{a} = \vert {v}_{a} - {v}_{r} \vert = S \cdot {t}_{a} = \frac{2 nS}{c} {L}_{a} & ( 1 ) \\ {f}_{b} = \vert {v}_{b} - {v}_{r} \vert = S \cdot {t}_{b} = \frac{2 nS}{c} {L}_{b} & ( 2 ) \\ {f}_{c} = \vert {v}_{c} - {v}_{r} \vert = S \cdot {t}_{c} = \frac{2 nS}{c} {L}_{c} & ( 3 )\end{matrix}$$

When Fourier transform is performed for a received signal, beat signals with the frequencies fₐ, f_{b}, and f_{c} that are proportional to the distances Lₐ, L_{b}, and L_{c} are observed by Equations 1 to 3, as illustrated in FIG. 2C. In this case, reflectance from each point assumes to be sufficiently small, and multiple-reflection is negligible. As described above, the distribution of reflection from a measurement target optical fiber in a longitudinal direction can be measured by the optical frequency domain reflectometry.

A structure including a linearization process will be described below. In the optical frequency domain reflectometry, a wavelength-swept light source in which an optical frequency changes linearly with respect to time is required. However, in the actual light source, the optical frequency deviates from a straight line. In particular, in the case of an external cavity laser that mechanically sweeps a wavelength, it is difficult to completely linearly change the optical frequency.

For example, there is a sweep in which the wavelength of light changes linearly with respect to time or a sweep in which the wavelength of light changes in a sinusoidal shape with respect to time. In the case of the sinusoidal sweep, only a region that is relatively close to a straight line in the sine wave is used to obtain a sweep close to a straight line. However, in this case, an available wavelength range is narrowed. Therefore, a method has been proposed which prepares an auxiliary interferometer separately from a measurement interferometer including a measurement target optical fiber and compensates non-linearity in wavelength sweep.

FIG. 3A illustrates the structure of optical frequency domain reflectometry including a linearization process. An optical splitter 2 splits light from a swept light source 1 into two light components and the two light components are input to an auxiliary interferometer 3 and a measurement interferometer 4, respectively. The auxiliary interferometer 3 splits the input light into two light components, gives different delay times to the two light components, and combines the two light components. For example, as illustrated in FIG. 3B, an optical coupler 31a splits the input light into two light components. One of the two light components is input to an optical coupler 34a through a delay fiber 32a with a predetermined length and the other light component is input to the optical coupler 34a, without passing through a delay fiber. Then, the two light components are combined.

Linearization means 5 that functions as a linearization unit performs a linearization process of compensating the non-linearity of the swept light source 1 for an output signal from the measurement interferometer 4, using an output signal from the auxiliary interferometer 3. For example, as illustrated in FIG. 3C, when a photodetector 11′ converts the output from the auxiliary interferometer 3 into an electric signal, a sinusoidal beat signal with a frequency that is proportional to a sweep speed is obtained. A sampling time calculation means 13 that functions as a sampling time calculation unit outputs the time when the phase of the sine wave is arranged at a regular interval. For example, when a comparator detects a zero-cross point of the sine wave, the output from the comparator rises such that the phase interval of the sine wave is 2π.

A photodetector 11 converts the output from the measurement interferometer 4 into an electric signal. Sampling means 15 that functions as a sampling unit performs sampling at the time obtained by adding a predetermined delay time δt to the output from sampling time calculation means 13 that functions as a sampling time calculation unit to convert the electric signal into a digital signal. FIG. 3C illustrates a structure in which sampling means 15 performs A/D conversion according to the output from the sampling time calculation means 13. However, A/D conversion may be performed for the output from the measurement interferometer 4 at a constant sampling frequency and re-sampling corresponding to the output from the sampling time calculation means 13 may be performed by digital processing. In this case, the same effect as described above is obtained.

Similarly, the sampling time calculation means 13 may perform A/D conversion for the output signal from the auxiliary interferometer 3 and detect the time when the phase of the sine wave is arranged at a regular interval, using digital processing. In a case in which a sampling time is calculated by digital processing, it is possible to easily obtain a phase interval other than 27c.

The linearization means 5 operates as follows. Qualitatively, in a case in which the sweep speed is high, the beat frequency of the output from the auxiliary interferometer 3 is high. The linearization means 5 samples the output signal from the measurement interferometer 4 at a high frequency. In a case in which the sweep speed is low, the beat frequency of the output from the auxiliary interferometer 3 is low. The linearization means 5 samples the output signal from the measurement interferometer 4 at a low frequency. In this way, the linearization means 5 obtains a measured signal corresponding to a case in which the sweep speed is constant.

Quantitatively, when the delay time is set to δt=τ/2, a first order error term is cancelled and an error caused by non-linearity in the sweep speed is reduced (for example, see Non-patent Document 1). Here, τ is the delay time difference between two optical paths in the auxiliary interferometer 3. Hereinafter, only the first order error term caused by a non-linear sweep is treated. A Fourier transform unit 60 performs Fourier transform for the output from the linearization means 5 to obtain the measurement result of the optical frequency domain reflectometry.

Next, an application example of the optical frequency domain reflectometry will be described. When light is continuously reflected in a longitudinal direction by the Rayleigh scattering of a measurement target optical fiber or a fiber Bragg grating (FBG) formed in the measurement target optical fiber and strain occurs in the longitudinal direction of the measurement target optical fiber, the phase of the reflected light caused by Rayleigh scattering or FBG changes. Therefore, the phase of the beat signal in the frequency domain obtained by the optical frequency domain reflectometry can be observed to measure the distribution of the very small strain of the measurement target optical fiber in the longitudinal direction.

In the related art, a method has been proposed which measures the position or shape of a measurement target optical fiber using a multi-core fiber with a plurality of cores (for example, see Patent Document 1). In Patent Document 1, a process of compensating non-linearity in laser sweep is performed for a signal from an interrogator network, using a signal from an interferometer in a laser monitoring network and it is necessary to compensate non-linearity in sweep in order to accurately measure very small strain.

### RELATED ART DOCUMENT

### Patent Document

[Patent Document 1] WO2011/034584

### Non-Patent Document

[Non-patent Document 1] Eric D. Moore and Robert R. McLeod, “Correction of sampling errors due to laser tuning rate fluctuations in swept-wavelength interferometry,” Optics Express, vol. 16, no. 17, pp. 13139-13149, 2008.

### DISCLOSURE OF THE INVENTION

### Problem that the Invention is to Solve

An error that occurs when optical frequency sweep is not linear can be corrected by the method disclosed in Non-patent Document 1. However, the correction by the method disclosed in Non-patent Document 1 is limited to a specific delay time.

That is, in a case in which the distribution of the strain of a measurement target optical fiber with a predetermined length is measured, an error can be corrected only at the specific position on the measurement target optical fiber corresponding to a specific delay time and the effect of correcting errors is reduced at the other positions. In particular, in a case in which the measurement target optical fiber is long, the amount of error at a position that is far away from the specific position is large.

An object of the invention is to compensate non-linearity in wavelength sweep in a wide distance range of a measurement target optical fiber in order to solve the above-mentioned problems.

### Means for Solving the Problem

In order to achieve the object, in the invention, a plurality of linearization processes with different delay times are performed, signals subjected to the plurality of linearization processes are weighted and added, Fourier transform is performed for the added signal, and a frequency domain signal is output.

Specifically, an optical frequency domain reflectometer according to the invention includes: a swept light source that outputs wavelength-swept light as output light; an auxiliary interferometer that inputs a portion of the output light from the swept light source to an auxiliary interference signal generating delay fiber, makes light output from the auxiliary interference signal generating delay fiber and another portion of the output light from the swept light source interfere with each other, and outputs an auxiliary interference signal; a measurement interferometer that inputs a portion of the output light from the swept light source to a measurement target optical fiber, makes light reflected from the measurement target optical fiber and another portion of the output light from the swept light source interfere with each other, and outputs a measurement interference signal; a plurality of linearization units that have different delay times, compensate non-linearity in the wavelength sweep of the swept light source for the measurement interference signal, using the auxiliary interference signal, and output the compensated signals as output signals; and a weighted addition and Fourier transform unit that outputs a frequency domain signal as a result of addition and Fourier transformation of weighted signals which are multiplying the output signals from the plurality of linearization units by different weights.

In the optical frequency domain reflectometer according to the invention, the weights of the weighted addition and Fourier transform unit may have, as a weighting characteristics, a characteristics that linearly change with respect to position on the measurement target optical fiber among each positions on the measurement target optical fiber which correspond to each of the delay times of the plurality of linearization units and where an error caused by the non-linearity in the wavelength sweep of the swept light source is a minimum.

In the optical frequency domain reflectometer according to the invention, the plurality of linearization units may be a first linearization unit and a second linearization unit that have different delay times, and the weighted addition and Fourier transform unit may output a frequency domain signal as a result of addition and Fourier transformation of weighted signals which are multiplying an output signal from the first linearization unit and an output signal from the second linearization unit by different weights.

The optical frequency domain reflectometer according to the invention may further include: a photodetector that converts the auxiliary interference signal from the auxiliary interferometer into an auxiliary electric signal; an A/D converter that converts the auxiliary electric signal into an auxiliary digital signal at a constant sampling frequency; a sampling time calculation unit that calculates a sampling time when a phase of the auxiliary digital signal is arranged at a regular interval; a photodetector that converts the measurement interference signal from the measurement interferometer into a measurement electric signal; and an A/D converter that converts the measurement electric signal into a measurement digital signal at a constant sampling frequency. The first linearization unit may include a first delay time addition unit that adds a first delay time to the sampling time to calculate a first sampling time and a first re-sampling unit that re-samples the measurement digital signal according to the first sampling time and outputs a first measurement digital signal. The second linearization unit may include a second delay time addition unit that adds a second delay time to the sampling time to calculate a second sampling time and a second re-sampling unit that re-samples the measurement digital signal according to the second sampling time and outputs a second measurement digital signal. An output signal from the first linearization unit may be the first measurement digital signal, and an output signal from the second linearization unit may be the second measurement digital signal.

The optical frequency domain reflectometer according to the invention may further include: a photodetector that converts the auxiliary interference signal from the auxiliary interferometer into an auxiliary electric signal; a sampling clock generation unit that generates a sampling clock with a frequency which is proportional to a frequency of the auxiliary electric signal; and a photodetector that converts the measurement interference signal from the measurement interferometer into a measurement electric signal. The first linearization unit may include a first delayer that adds a first delay time to the sampling clock and outputs a first sampling clock and a first A/D converter that converts the measurement electric signal into a first measurement digital signal according to the first sampling clock. The second linearization unit may include a second delayer that adds a second delay time to the sampling clock and outputs a second sampling clock and a second A/D converter that converts the measurement electric signal into a second measurement digital signal according to the second sampling clock. An output signal from the first linearization unit may be the first measurement digital signal and an output signal from the second linearization unit may be the second measurement digital signal.

The optical frequency domain reflectometer according to the invention may further include a photodetector that converts the measurement interference signal from the measurement interferometer into a measurement electric signal. The first linearization unit may include: a first delay fiber that adds a first delay time to the auxiliary interference signal from the auxiliary interferometer; a first photodetector that converts output light from the first delay fiber into a first auxiliary electric signal; a first sampling clock generation unit that generates a first sampling clock from the first auxiliary electric signal; and a first A/D converter that converts the measurement electric signal into a first measurement digital signal according to the first sampling clock. The second linearization unit may include: a second delay fiber that adds a second delay time to the auxiliary interference signal from the auxiliary interferometer; a second photodetector that converts output light from the second delay fiber into a second auxiliary electric signal; a second sampling clock generation unit that generates a second sampling clock from the second auxiliary electric signal; and a second A/D converter that converts the measurement electric signal into a second measurement digital signal according to the second sampling clock. An output signal from the first linearization unit may be the first measurement digital signal, and an output signal from the second linearization unit may be the second measurement digital signal.

The optical frequency domain reflectometer according to the invention may further include: a photodetector that converts the auxiliary interference signal from the auxiliary interferometer into an auxiliary electric signal; and a sampling clock generation unit that generates a sampling clock with a frequency which is proportional to a frequency of the auxiliary electric signal. The first linearization unit may include: a first delay fiber that adds a first delay time to the measurement interference signal from the measurement interferometer; a first photodetector that converts output light from the first delay fiber into a first measurement electric signal; and a first A/D converter that converts the first measurement electric signal into a first measurement digital signal according to the sampling clock. The second linearization unit may include: a second delay fiber that adds a second delay time to the measurement interference signal from the measurement interferometer; a second photodetector that converts output light from the second delay fiber into a second measurement electric signal; and a second A/D converter that converts the second measurement electric signal into a second measurement digital signal according to the sampling clock. An output signal from the first linearization unit may be the first measurement digital signal and an output signal from the second linearization unit may be the second measurement digital signal.

In the optical frequency domain reflectometer according to the invention, the sampling time calculation unit may include: a digital filter that converts the auxiliary digital signal into a complex digital signal; a phase calculation unit that calculates a phase of the complex digital signal; and a time calculation unit that calculates a time when the phase is arranged at a regular interval.

In the optical frequency domain reflectometer according to the invention, the sampling clock generation unit may be a comparator that compares the auxiliary electric signal with a predetermined voltage and outputs the sampling clock.

In the optical frequency domain reflectometer according to the invention, the first sampling clock generation unit may be a comparator that compares the first auxiliary electric signal with a predetermined voltage and outputs the first sampling clock and the second sampling clock generation unit may be a comparator that compares the second auxiliary electric signal with a predetermined voltage and outputs the second sampling clock.

In the optical frequency domain reflectometer according to the invention, the weighted addition and Fourier transform unit may include: a first time domain filter that applies a first weight characteristic to the first measurement digital signal and performs first delay time adjustment; a second time domain filter that applies a second weight characteristic to the second measurement digital signal and performs second delay time adjustment; an adder that adds an output from the first time domain filter and an output from the second time domain filter; and a Fourier transform unit that performs Fourier transform for an output from the adder.

In the optical frequency domain reflectometer according to the invention, the weighted addition and Fourier transform unit may include: a first Fourier transform unit that performs Fourier transform for the first measurement digital signal; a second Fourier transform unit that performs Fourier transform for the second measurement digital signal; a first frequency domain filter that applies a first weight characteristic to an output signal from the first Fourier transform unit and performs first delay time adjustment; a second frequency domain filter that applies a second weight characteristic to an output signal from the second Fourier transform unit and performs second delay time adjustment; and an adder that adds an output signal from the first frequency domain filter and an output signal from the second frequency domain filter.

Specifically, an optical frequency domain reflectometry method according to the invention inputs wavelength-swept light to an auxiliary interferometer and a measurement interferometer including a measurement target optical fiber, performs a linearization process of compensating non-linearity in a wavelength sweep for an output signal from the measurement interferometer, using an output signal from the auxiliary interferometer, performs Fourier transform for a result of the linearization process, and outputs a frequency domain signal. The optical frequency domain reflectometry method includes; performing a plurality of linearization processes with different delay times; weighting signals subjected to the plurality of linearization processes; adding results of the weighting; performing Fourier transform for result of the adding; and outputting the frequency domain signal.

The above-mentioned structures according to the invention may be combined with each other, if possible.

### Advantage of the Invention

According to the invention, it is possible to compensate non-linearity in wavelength sweep in a wide distance range of a measurement target optical fiber.

### BRIEF DESCRIPTION OF THE DRAWINGS

FIGS. 1A and 1B are a diagram illustrating an example of the structure of an optical frequency domain reflectometry according to the related art.

FIGS. 2A to 2C are a diagram illustrating an example of the basic operation of an optical frequency domain reflectometry in which three reflection points are assumed.

FIGS. 3A to 3C are a diagram illustrating an example of the structure of an optical frequency domain reflectometry including a linearization process.

FIG. 4 is a diagram illustrating an example of the structure of an optical frequency domain reflectometer according to this embodiment.

FIG. 5 is a diagram illustrating an example of the structure of an optical frequency domain reflectometer according to Embodiment 1.

FIG. 6 is a diagram illustrating an example of the structure of an optical frequency domain reflectometer according to Embodiment 2.

FIG. 7 is a diagram illustrating an example of the structure of an optical frequency domain reflectometer according to Embodiment 3.

FIG. 8 is a diagram illustrating an example of the structure of an optical frequency domain reflectometer according to Embodiment 4.

FIG. 9 is a diagram illustrating an example of the structure of an optical frequency domain reflectometer according to Embodiment 5.

FIGS. 10A to 10E are a diagram illustrating an example of the structure of an auxiliary interferometer in the optical frequency domain reflectometer according to this embodiment.

FIGS. 11A to 11H are a diagram illustrating an example of the structure of a measurement interferometer in the optical frequency domain reflectometer according to this embodiment.

FIGS. 12A to 12C are a diagram illustrating an example of a structure in a case in which light is received by a polarization diversity method in the optical frequency domain reflectometer according to this embodiment.

FIGS. 13A to 13D are a diagram illustrating an example of the structure of sampling time calculation means according to this embodiment.

FIGS. 14A to 14F are a diagram illustrating an example of the structure of weighted addition and Fourier transform means according to this embodiment.

FIGS. 15A to 15C are a diagram illustrating an example of the structure of sampling clock generation means according to this embodiment.

FIGS. 16A to 16C are a diagram illustrating an example of the setting of weights according to this embodiment.

FIGS. 17A to 17C are a diagram illustrating an example of the setting of the delay times according to this embodiment.

FIGS. 18A to 18C are a diagram illustrating an example of the setting of weights in a case in which there are three systems of linearization means in this embodiment.

FIGS. 19A to 19C are a diagram illustrating an example of the setting of weights in a case in which there are three systems of linearization means in this embodiment.

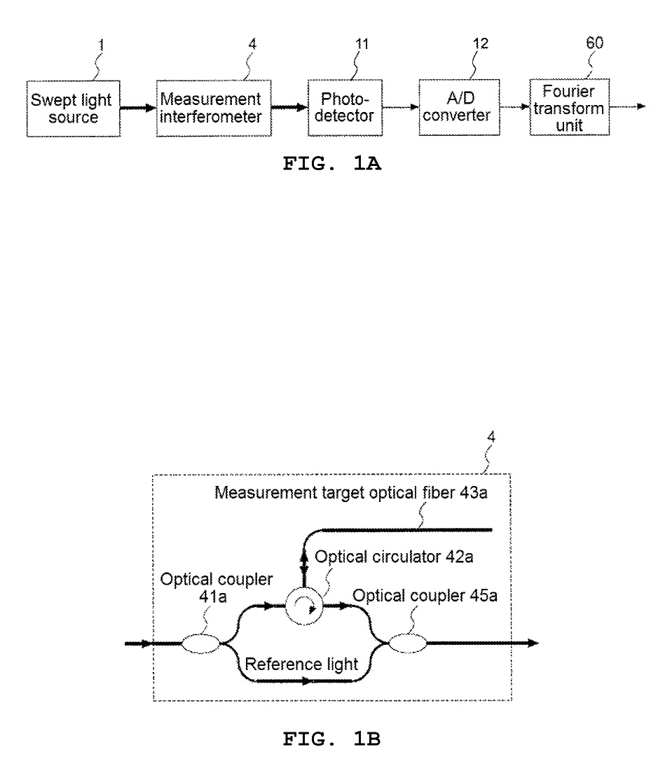

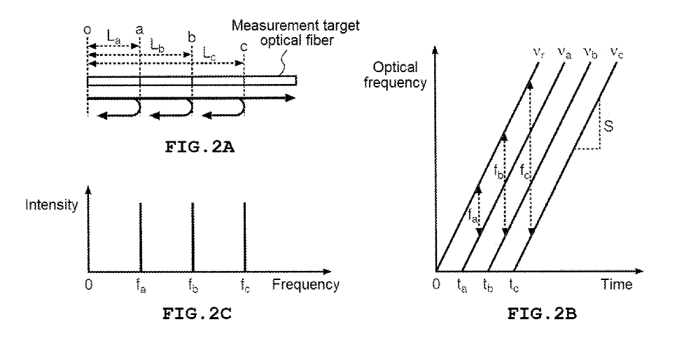

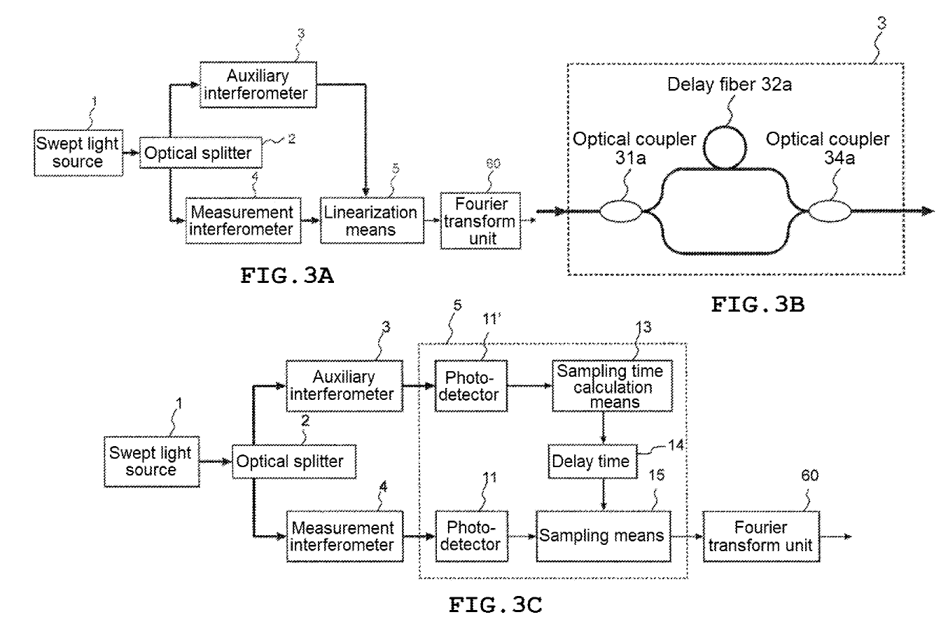

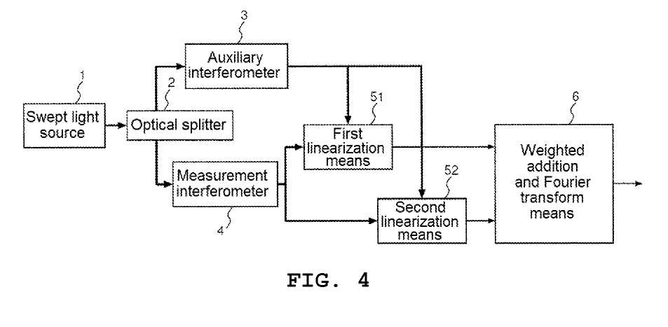

### BEST MODE FOR CARRYING OUT THE INVENTION

Hereinafter, embodiments of the invention will be described in detail with reference to the drawings. The invention is not limited to the following embodiments. The embodiments are illustrative and various modifications and improvements of the invention can be made on the basis of the knowledge of those skilled in the art. In the specification and the drawings, the same components are denoted by the same reference numerals.

FIG. 4 illustrates the basic structure of an optical frequency domain reflectometer according to the invention. The optical frequency domain reflectometer includes a swept light source 1, an optical splitter 2, an auxiliary interferometer 3, a measurement interferometer 4, weighted addition and Fourier transform means 6, first linearization means 51, and second linearization means 52.

The swept light source 1 sweeps the wavelength of output light. The wavelength may be swept only once, may be repeatedly swept with a predetermined period, or may be swept in response to a trigger signal (not illustrated) from the outside. A sweep direction may be a direction from a long wavelength to a short wavelength, a direction from the short wavelength to the long wavelength, or the two directions. For example, in an external cavity laser using a diffraction grating, the angle of the diffraction grating or the angle of a mirror can be changed to change a resonant wavelength, thereby sweeping a lasing wavelength.

In an optical frequency domain reflectometry, a sweep in which the frequency of light completely linearly changes with respect to time is ideal. However, in practice, deviation from a straight line occurs. For example, there are the following sweeps: a sweep in which the wavelength of light linearly changes with respect to time; and a sweep in which the wavelength of light changes in a sinusoidal shape. In the sinusoidal sweep, only a region that is relatively close to a straight line in the sine wave is used. Therefore, the sinusoidal sweep can be regarded as a sweep close to a straight line.

The optical splitter 2 splits light output from the swept light source 1 into two light components and inputs the two light components to the auxiliary interferometer 3 and the measurement interferometer 4, respectively. Here, a structure in which the optical splitter 2 splits light into two light components and each of the auxiliary interferometer 3 and the measurement interferometer 4 further splits the light component into two light components. However, the invention is not limited thereto. The split order may be reversed or light may be split into four light components at one time.

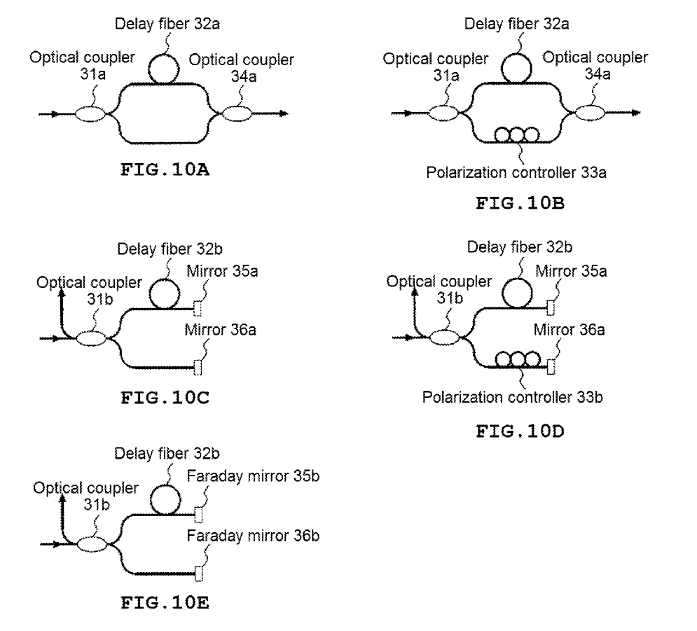

The auxiliary interferometer 3 splits the input light into two light components, gives different delay times to the two light components, and combines the two light components. For example, as illustrated in FIG. 10A, an optical coupler 31a splits the input light into two light components. One of the two light components is input to an optical coupler 34a through a delay fiber 32a with a predetermined length and the other light component is input to the optical coupler 34a, without passing through a delay fiber. Then, the two light components are combined. In this case, it is necessary to combine the two light components such that the polarizations of the two light components are not orthogonal to each other. It is preferable to combine the two light components with the same polarization.

When the optical fiber and the optical coupler are formed by a polarization maintaining fiber, it is possible to combine two light components with the same polarization. In a case in which the optical fiber or the optical coupler is not the polarization maintaining fiber, the polarization of at least one of two split light components is adjusted by a polarization controller 33a, as illustrated in FIG. 10B.

In addition, the structure illustrated in FIG. 10C may be used in which an optical coupler 31b splits the input light into two light components, one of the two light components passes through a delay fiber 32b with a predetermined length and is reflected from a mirror 35a, the other light component is reflected from a mirror 36a, without passing through a delay fiber, the reflected light components are propagated through the same path in an opposite direction and are combined by the optical coupler 31b, and light is output from a port different from an input port.

In this structure, when the optical fiber and the optical coupler are formed by a polarization maintaining fiber, it is possible to combine two light components with the same polarization. In a case in which the optical fiber or the optical coupler is not the polarization maintaining fiber, the polarization of at least one of two split light components is adjusted by a polarization controller 33b, as illustrated in FIG. 10D. Alternatively, as illustrated in FIG. 10E, Faraday mirrors 35b and 36b can be used to combine the two light components with the same polarization at the optical coupler 31b, without using a polarization maintaining fiber or a polarization controller.

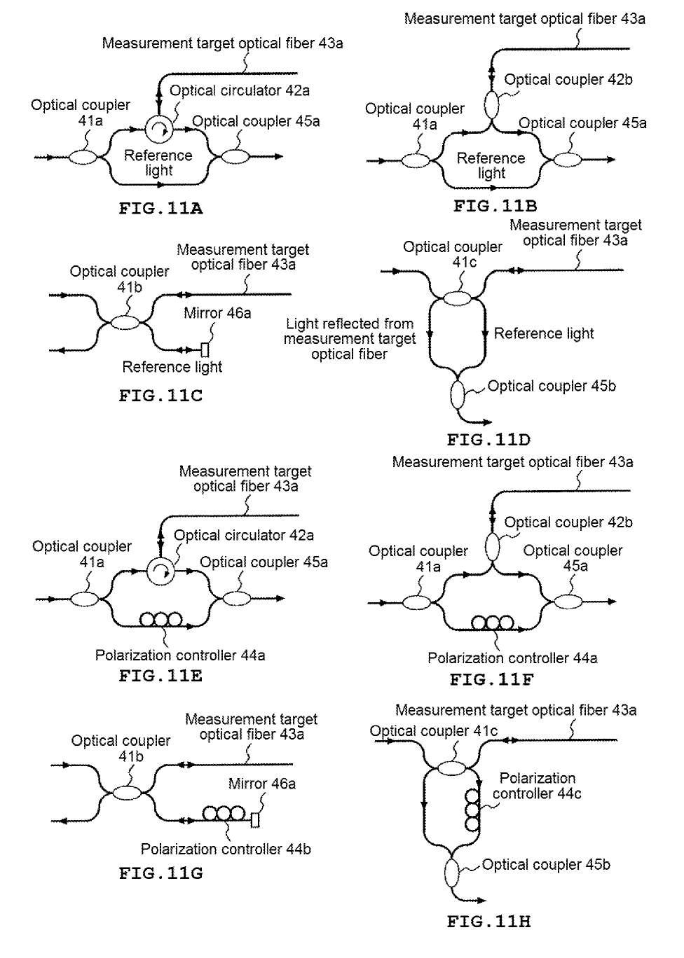

The measurement interferometer 4 splits the input light into two light components and inputs one of the two light components to a measurement target optical fiber. Then, light reflected from the measurement target optical fiber and the other light component (reference light) are combined and output. For example, as illustrated in FIG. 11A, an optical coupler 41a splits the input light into two light components and inputs one of the two light components to a first terminal of an optical circulator 42a. The light input to the first terminal of the optical circulator 42a is output from a second terminal and is input to a measurement target optical fiber 43a. Light reflected from the measurement target optical fiber 43a is input to the second terminal of the optical circulator 42a and is output from a third terminal. An optical coupler 45a combines light output from the third terminal of the optical circulator 42a and the other light component (reference light) split by the optical coupler 41a and outputs the combined light.

An optical coupler 42b may be used instead of the optical circulator 42a, as illustrated in FIG. 11B. In addition, the structure illustrated in FIG. 11C may be used. In the structure, an optical coupler 41b splits the input light into two light components, inputs one of the two light components to the measurement target optical fiber 43a, and inputs the other light component to a mirror 46a. The optical coupler 41b combines light reflected from the measurement target optical fiber 43a and light (reference light) reflected from the mirror 46a and outputs the combined light from a port different from an input port.

The structure illustrated in FIG. 11D may be used in which an optical coupler 41c splits the input light into two light components and inputs one of the two light components to the measurement target optical fiber 43a and an optical coupler 45b combines the other light component (reference light) and light that has been reflected from the measurement target optical fiber 43a and then passed through the optical coupler 41c and outputs the combined light.

Similarly to the auxiliary interferometer, combining needs to be performed such that the polarizations of two light components are not orthogonal to each other. In a case in which the optical fiber is not a polarization maintaining fiber, the polarization of at least one of two split light components is adjusted by the polarization controllers 44a, 44b, and 44c, as illustrated in FIGS. 11E, 11F, 11G, and 11H.

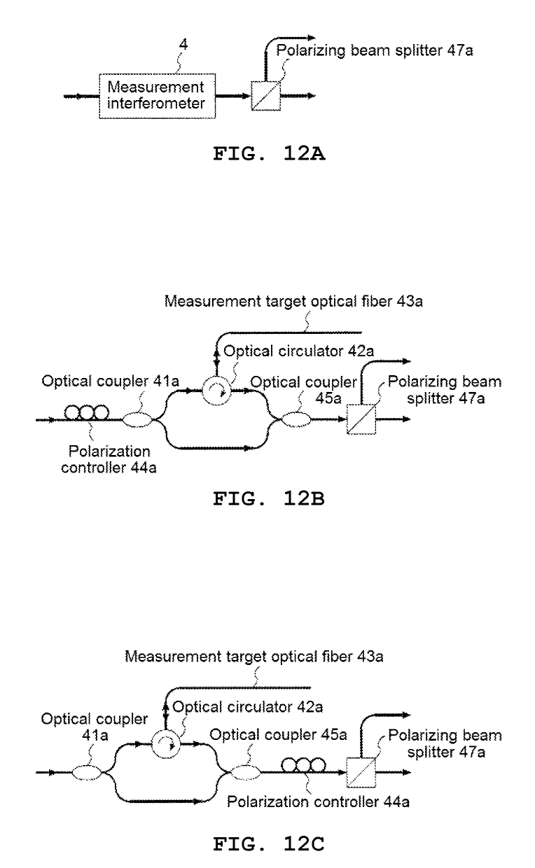

In a case in which the polarization of light is changed while the light is propagated through the measurement target optical fiber 43a, the polarization of reflected light varies depending on a reflection position on the measurement target optical fiber 43a. In this case, a polarization diversity method is used which separates light output from the measurement interferometer 4 into two polarized waves that are orthogonal to each other, using a polarizing beam splitter 47a, and receives the two polarized waves, as illustrated in FIG. 12A.

At that time, it is necessary to prevent the reference light from being orthogonal to the polarization directions of the polarizing beam splitter 47a. It is preferable that the polarizing beam splitter 47a splits the reference light substantially at a ratio of one to one. The path of at least the reference light is formed by a polarization maintaining fiber or the polarization of the reference light is adjusted by the polarization controller as in the structures illustrated in FIGS. 11E, 11F, 11G, and 11H.

In the polarization diversity method, it is preferable to adjust the polarization of the reference light input to the polarizing beam splitter 47a. Therefore, the polarization controllers 44a, 44b, and 44c may be provided in front of the optical couplers 41a, 41b, and 41c or may be provided behind the optical couplers 45a, 41b, and 45b, respectively. For example, the case in which the polarization controller 44a illustrated in FIG. 11E is provided in front of the optical coupler 41a corresponds to FIG. 12B and the case in which the polarization controller 44a is provided behind the optical coupler 45a corresponds to FIG. 12C.

When the optical frequency of the swept light source varies non-linearly with respect to time, a beat frequency caused by the interference between the reference light and light reflected from a predetermined position on the measurement target optical fiber 43a in the measurement interferometer 4 varies over time. The first linearization means 51 that functions as a first linearization unit performs sampling, using the output from the auxiliary interferometer 3, such that the beat frequency caused by the interference between the reference light and light reflected from a predetermined position on the measurement target optical fiber 43a in the measurement interferometer 4 is constant.

Specifically, the first linearization means 51 samples a beat signal output from the measurement interferometer 4 at a frequency that is proportional to the beat frequency output from the auxiliary interferometer 3. That is, the first linearization means samples the beat signal output from the measurement interferometer 4 at the time when the phase of the sine wave of the beat signal output from the auxiliary interferometer 3 is arranged at a regular interval. The second linearization means 52 that functions as a second linearization unit has the same structure as the first linearization means 51 and samples the beat signal output from the measurement interferometer 4 at the time when the phase of the sine wave of the beat signal output from the auxiliary interferometer 3 is arranged at a regular interval.

In the first linearization means 51 and the second linearization means 52, the relative time differences between the output signal from the auxiliary interferometer 3 and the output signal from the measurement interferometer 4 are set to different values. Specifically, at least one of the output signal from the auxiliary interferometer 3 and the output signal from the measurement interferometer 4 is delayed. In a case in which both the two output signals are delayed, a delay time difference is different in the first linearization means 51 and the second linearization means 52.

The weighted addition and Fourier transform means 6 that functions as a weighted addition and Fourier transform unit multiplies the output signal from the first linearization means 51 and the output signal from the second linearization means 52 by the weights which vary depending on the position on the measurement target optical fiber 43a, adds the weighted output signals, performs Fourier transform for the added signal, and outputs the result.

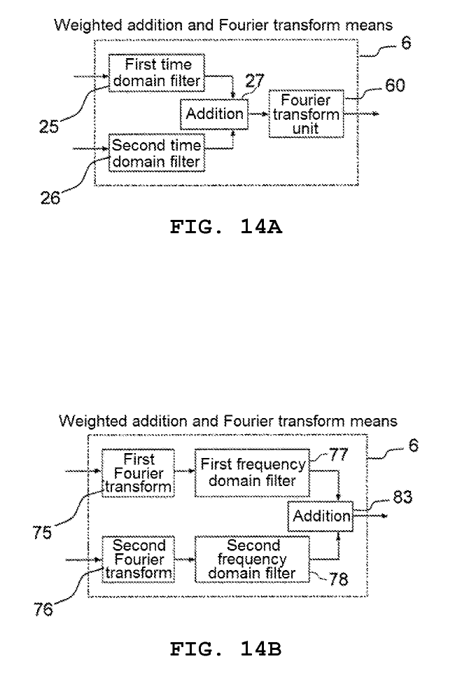

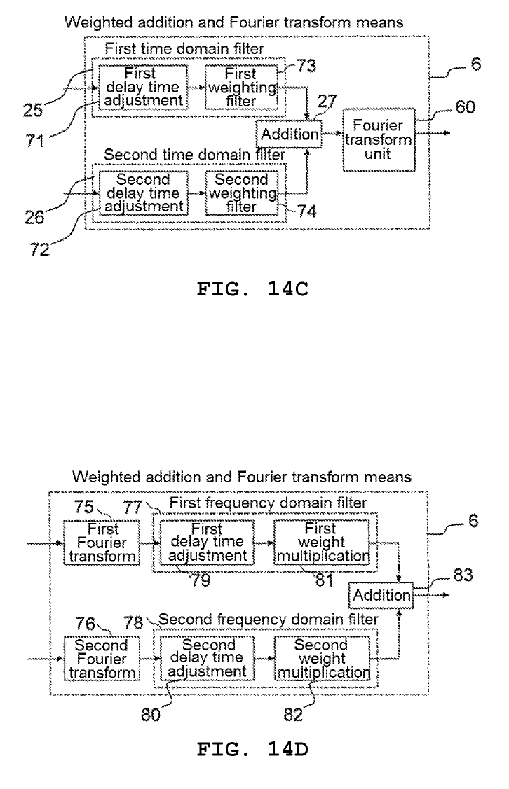

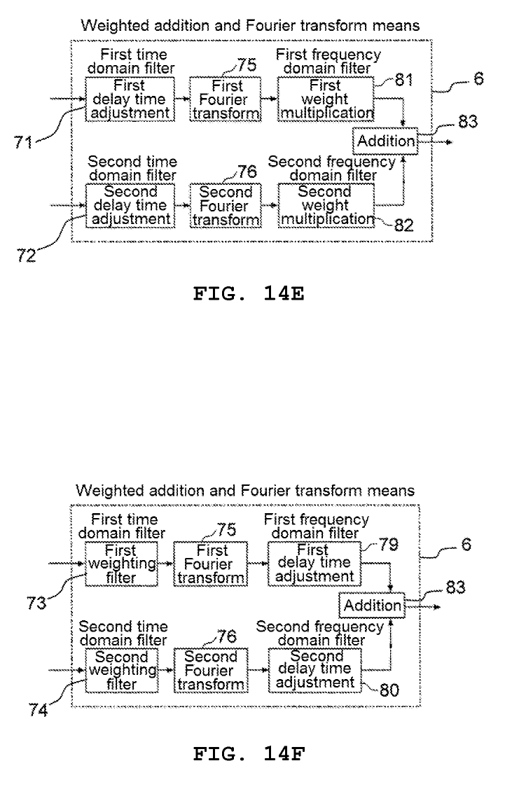

For example, as illustrated in FIG. 14A, the weighted addition and Fourier transform means 6 applies a first time domain filter 25 with a predetermined frequency characteristic to the output signal from the first linearization means 51, applies a second time domain filter 26 with a frequency characteristic that is different from the predetermined frequency characteristic to the output signal from the second linearization means 52, adds the output signals, performs Fourier transform for the added signal, and outputs the result. The amplitudes of the frequency characteristics of the first time domain filter 25 and the second time domain filter 26 correspond to weights depending on the position on the measurement target optical fiber 43a.

As illustrated in FIG. 14B, the weighted addition and Fourier transform means 6 may perform Fourier transform for the output signal from the first linearization means 51, apply a first frequency domain filter 77 to the signal, perform Fourier transform for the output signal from the second linearization means 52, apply a second frequency domain filter 78 to the signal, add the two signals, and output the added signal.

While the time domain filter requires convolution, the frequency domain filter requires only multiplication. Therefore, the amount of calculation of the filter is reduced, but Fourier transform needs to be performed two times. The amplitude of a coefficient of the first frequency domain filter 77 and the amplitude of a coefficient of the second frequency domain filter 78 correspond to the weights depending on the position on the measurement target optical fiber 43a.

The weighted addition and Fourier transform means 6 may have a function of adjusting the delay time difference between the output signal from the first linearization means 51 and the output signal from the second linearization means 52. In this case, preferably, the delay time difference between the output signal from the first linearization means 51 and the output signal from the second linearization means 52 is set such that an error term after first linearization and an error term after second linearization which are caused by non-linearity are reversed in phase and cancelled in the time domain in which non-linearity in the sweep of the optical frequency of the swept light source 1 is large.

The delay time can be adjusted by inserting delay time adjustment means functioning as a delay time adjustment unit that adds a delay corresponding to an integer sample to at least one of the output signal from the first linearization means 51 and the output signal from the second linearization means 52 or interpolates samples and adds a delay less than a sampling interval to the at least one of the output signals. The time domain filter or the frequency domain filter may include delay time adjustment.

In a case in which the time domain filter includes delay time adjustment, the phase slope of the frequency characteristics of the time domain filter corresponds to the delay time. In a case in which the frequency domain filter includes delay time adjustment, the phase slope of the coefficient of the frequency domain filter corresponds to the delay time. The delay time adjustment and weighting need to be performed before addition. The order of the other processes can be arbitrarily changed and various embodiments can be made.

For example, as illustrated in FIG. 14C, a process may be performed in the order of delay time adjustment 71 or 72, a weighting filter 73 or 74, addition 27, and Fourier transform unit 60. The order of the delay time adjustment 71 or 72 and the weighting filter 73 or 74 may be reversed or the delay time adjustment 71 or 72 and the weighting filter 73 or 74 may be implemented by one time domain filter 25 or 26. As illustrated in FIG. 14D, a process may be performed in the other of Fourier transform or 76, delay time adjustment 79 or 80, weight multiplication 81 or 82, and addition 83. Alternatively, the order of the delay time adjustment 79 or 80 and the weight multiplication 81 or 82 may be reversed or the delay time adjustment 79 or 80 and the weight multiplication 81 or 82 may be implemented by one frequency domain filter 77 or 78.

As illustrated in FIG. 14E, a process may be performed in the order of the delay time adjustment 71 or 72, the Fourier transform 75 or 76, the weight multiplication 81 or 82, and the addition 83. As illustrated in FIG. 14F, a process may be performed in the order of the weighting filter 73 or 74, the Fourier transform 75 or 76, the delay time adjustment 79 or 80, and the addition 83. Similarly, third linearization means that functions as a third linearization unit may be provided and weighted addition and Fourier transform may be performed for three signals with different delay times. Alternatively, the invention may be extended to the structure in which a plurality of linearization means are provided and weighted addition and Fourier transform are performed for a plurality of signals with different delay times.

### First Embodiment

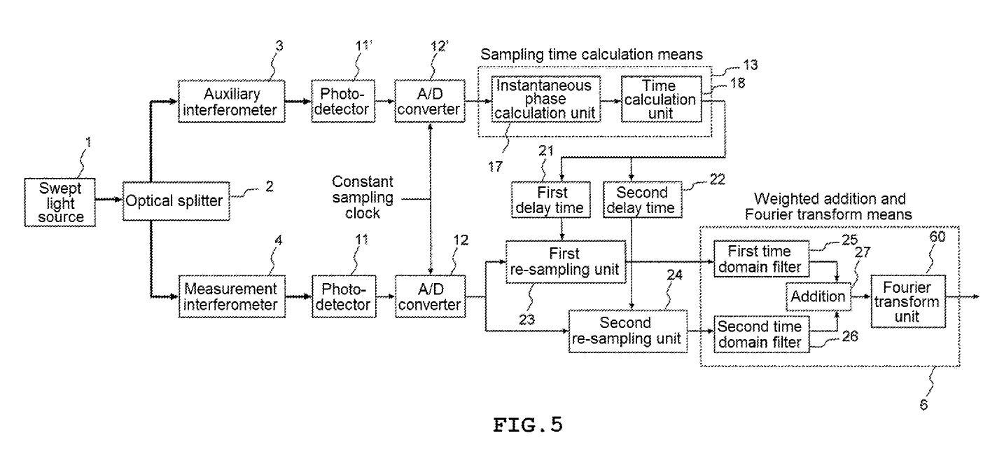

A first embodiment of the invention will be described with reference to FIG. 5. A swept light source 1, an optical splitter 2, an auxiliary interferometer 3, and a measurement interferometer 4 have the same basic structure as those illustrated in FIG. 4. A photodetector 11′ converts light output from the auxiliary interferometer 3 into an electric signal. The photodetector 11′ outputs a current or a voltage that is proportional to light intensity and outputs a beat signal generated by the interference between two light components combined by the auxiliary interferometer 3.

The auxiliary interferometer 3 combines two light components with different delay times. Therefore, a sinusoidal signal with a frequency that is proportional to the optical frequency sweep rate of the light source is obtained. The signal output from the photodetector 11′ is input to an A/D converter 12′ and the A/D converter 12′ converts the input signal into a digital signal at a constant sampling frequency. An instantaneous phase calculation unit 17 calculates the instantaneous phase of the sinusoidal beat signal output from the A/D converter 12′. A time calculation unit 18 outputs the time when the instantaneous phase is arranged at a regular interval as the sampling time.

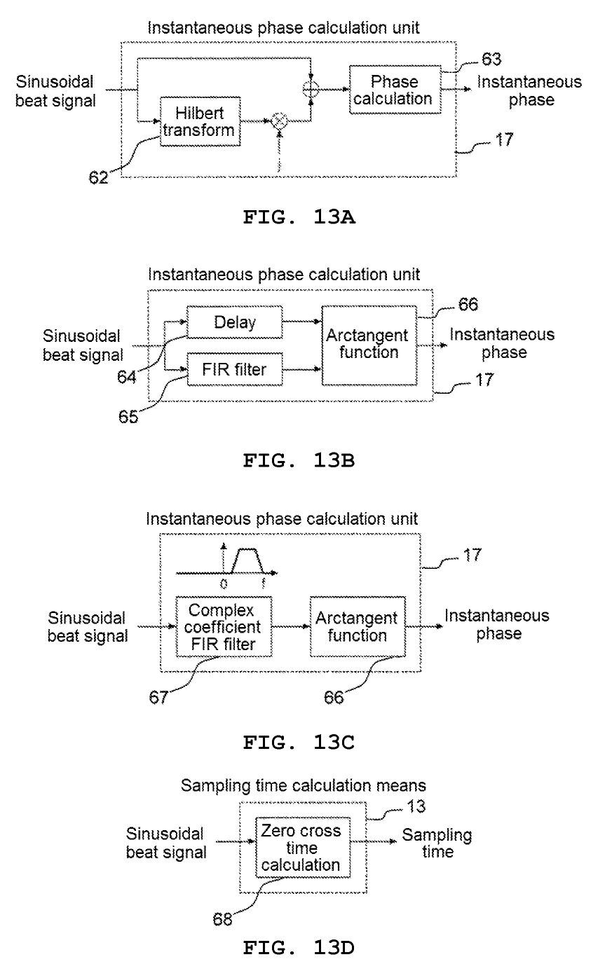

The instantaneous phase calculation unit 17 performs Hilbert transform (62) for the sinusoidal beat signal, multiplies the converted signal by an imaginary unit j, adds the converted signal and the sinusoidal beat signal to obtain a complex number, and performs calculation (63) for the phase of the complex number, as illustrated in FIG. 13A. In practice, as illustrated in FIG. 13B, when Hilbert transform is implemented by an FIR filter 65, a delay occurs. Therefore, it is necessary to insert a delay unit 64 into the path of a real part to synchronize the delay time of the real part and the delay time of the imaginary part. An instantaneous phase can be calculated from the values of the real part and the imaginary part by an arctangent function 66.

Alternatively, as illustrated in FIG. 13C, the instantaneous phase may be calculated by a complex-coefficient FIR filter 67 that transmits a positive frequency domain corresponding to at least a sinusoidal beat signal and blocks a negative frequency domain corresponding to the sinusoidal beat signal. The time calculation unit calculates the time when the instantaneous phases is arranged at a regular interval, considering that the instantaneous phase is wrapped to, for example, a value from −π to π. Alternatively, the time calculation unit may unwrap the instantaneous phase and detect the time when the unwrapped phase is arranged at a regular interval.

In sampling time calculation means 13 including the instantaneous phase calculation unit 17 and the time calculation unit 18, the phase interval is not limited to 27c and can be set to an arbitrary value. There is the advantage that flexibility in the design of, for example, the length of the measurement target optical fiber or a delay time difference in the auxiliary interferometer 3 increases.

The sampling time calculation means 13 may calculate (68) the time when a sinusoidal beat signal crosses zero and output the time as the sampling time, as illustrated in FIG. 13D. In a method for calculating the time when the sinusoidal beat signal crosses zero, a sampling frequency is limited to two times the frequency of the sinusoidal beat signal or one over an integer when the frequency of the sinusoidal beat signal is divided.

A first delay time 21 and a second delay time 22 are added to the output from the sampling time calculation means 13 and the added values are output as a first sampling time and a second sampling time. A photodetector converts the output light from the measurement interferometer 4 into an electric signal. The photodetector 11 outputs a current or a voltage that is proportional to light intensity and outputs a beat signal generated by the interference between light reflected from the measurement target optical fiber and the reference light.

A/D conversion (12) is performed for the electric signal output from the photodetector 11 at a constant sampling frequency and the converted signal is input to a first re-sampling unit 23 and a second re-sampling unit 24. The first re-sampling unit 23 outputs a temporal signal indicated by the first sampling time as a first digital signal. The second re-sampling unit 24 outputs a temporal signal indicated by the second sampling time as a second digital signal.

The invention is not limited to the structure in which the time indicated by each sampling time is not equal to the sampling time of the A/D converter 12. Therefore, each of the re-sampling units 23 and 24 interpolates the A/D-converted digital signals and outputs the interpolated signals. Specifically, an interpolated signal is calculated from a finite number of A/D-converted digital signals in the vicinity of the time indicated by each sampling time by a FIR digital filter.

The first digital signal is input to a first time domain filter 25 and the second digital signal is input to a second time domain filter 26. Outputs from each filter are added (27). Then, Fourier transform (60) is performed for the added signal and the result is output. As described above, in the embodiment illustrated in FIG. 5, the photodetector 11′, the A/D converter 12′, and the sampling time calculation means 13 to which output light from the auxiliary interferometer 3 is input and the photodetector 11 and the A/D converter 12 to which output light from the measurement interferometer 4 is input do not depend on the difference between the first delay time and the second delay time 22 and are shared by the first linearization means 51 and the second linearization means 52 illustrated in FIG. 4.

Therefore, it is possible to obtain the effect of the invention while preventing an increase in the number of components. For example, when the first delay time addition 21, the second delay time addition 22, the first re-sampling unit 23, the second re-sampling unit 24, the first time domain filter 25, the second time domain filter 26, and the addition 27 are implemented by software processing, it is possible to achieve the invention, without increasing the number of hardware components, such as photodetectors or A/D converters. In a case in which the embodiment is particularly applied to a multi-channel measurement device including one auxiliary interferometer and a plurality of measurement interferometers disclosed in Patent Document 1, the embodiment has the great advantage that it is not necessary to increase the number of photodetectors or A/D converters.

### Second Embodiment

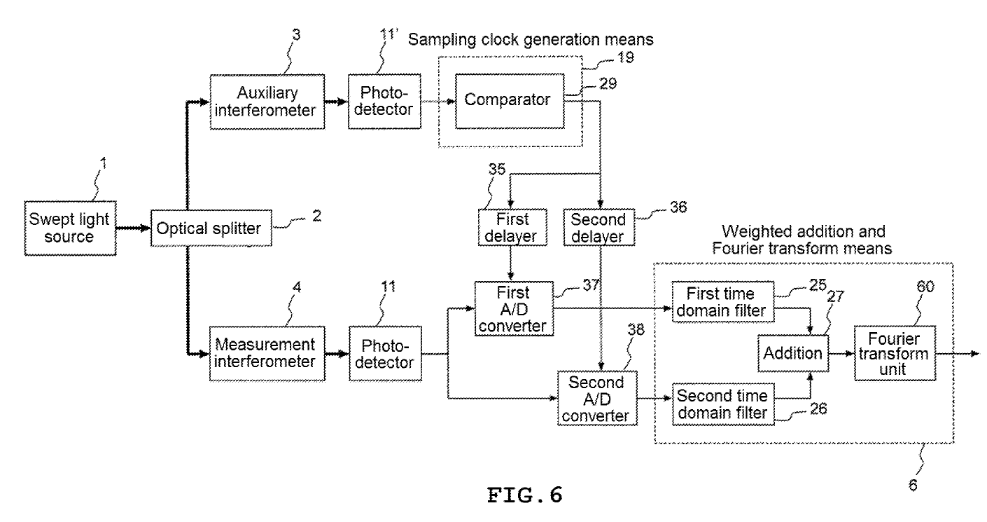

A second embodiment of the invention will be described with reference to FIG. 6. A swept light source 1, an optical splitter 2, an auxiliary interferometer 3, a measurement interferometer 4, photodetectors 11 and 11′, and weighted addition and Fourier transform means 6 have the same structure as those in the first embodiment. An electric signal that is output from the photodetector 11′ provided on the auxiliary interferometer side is input to a comparator 29 and is converted into a sampling clock corresponding to a zero-cross point of a sinusoidal signal.

That is, since the electric signal output from the photodetector 11′ is a sinusoidal signal, the electric signal is converted into a square-wave signal suitable for a sampling clock of the A/D converter by the comparator. In a case in which a sinusoidal signal can be input as the sampling clock of the A/D converter, the comparator 29 may not be provided.

The sampling clock output from the comparator 29 is input to a first delayer 35 and a second delayer 36 and different delay times are added to the sampling clock. Then, the sampling clocks are output as a first sampling clock and a second sampling clock. The order of the comparator 29 and the delayers 35 and 36 may be reversed. In this case, two comparators are required.

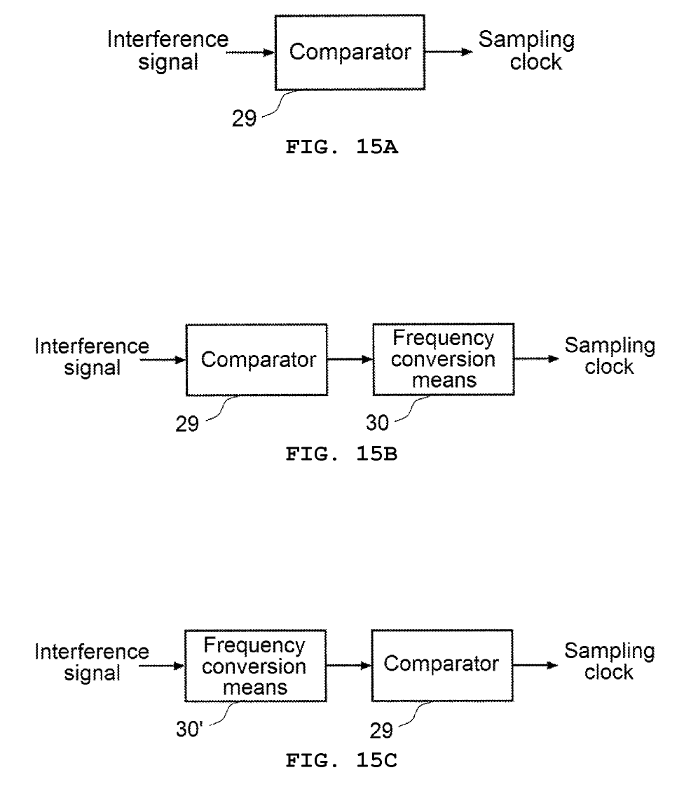

Sampling clock generation means 19 that functions as a sampling clock generation unit may include only the comparator 29 illustrated in FIG. 15A. The sampling clock generation means 19 may include frequency conversion means 30 functioning as a frequency conversion unit, such as a frequency divider, which changes the frequency of the output from the comparator 29 to generate a sampling clock, in addition to the comparator 29, as illustrated in FIG. 15B. Alternatively, the sampling clock generation means 19 may include frequency conversion means 30′, such as a phase-locked loop (PLL), which changes the frequency of an input signal and inputs the signal to the comparator 29 in order to generate a sampling clock, in addition to the comparator 29, as illustrated in FIG. 15C.

In a delay line that physically delays the sampling clock, it is difficult to add a negative delay time. In a case in which it is necessary to add the negative delay time, a delay fiber or a delay line may be added to the measurement interferometer side such that the delay time on the auxiliary interferometer side is positive. The first sampling clock and the second sampling clock are used as the sampling clocks of a first A/D converter 37 and a second A/D converter 38, respectively.

The first A/D converter 37 samples the electric signal output from the photodetector 11 on the measurement interferometer side according to the first sampling clock and converts the electric signal into a first digital signal. The second A/D converter 38 samples the electric signal output from the photodetector 11 on the measurement interferometer side according to the second sampling clock and converts the electric signal into a second digital signal.

As described above, in the embodiment illustrated in FIG. 6, the photodetector 11′ and the comparator 29 to which output light from the auxiliary interferometer 3 is input and the photodetector 11 to which output light from the measurement interferometer 4 is input do not depend on the difference between the first delay time and the second delay time and are shared by the first linearization means 51 and the second linearization means 52. Therefore, it is possible to obtain the effect of the invention while preventing an increase in the number of components.

This structure has the special feature that the sampling time calculation means 13 and the re-sampling units 23 and 24 according to the first embodiment are not required and it is possible to reduce the amount of calculation. However, two A/D converters need to be provided on the measurement interferometer side. Therefore, in a case in which the embodiment is applied to the multi-channel measurement device including one auxiliary interferometer and a plurality of measurement interferometers disclosed in Patent Document 1, the size of hardware increases.

### Third Embodiment

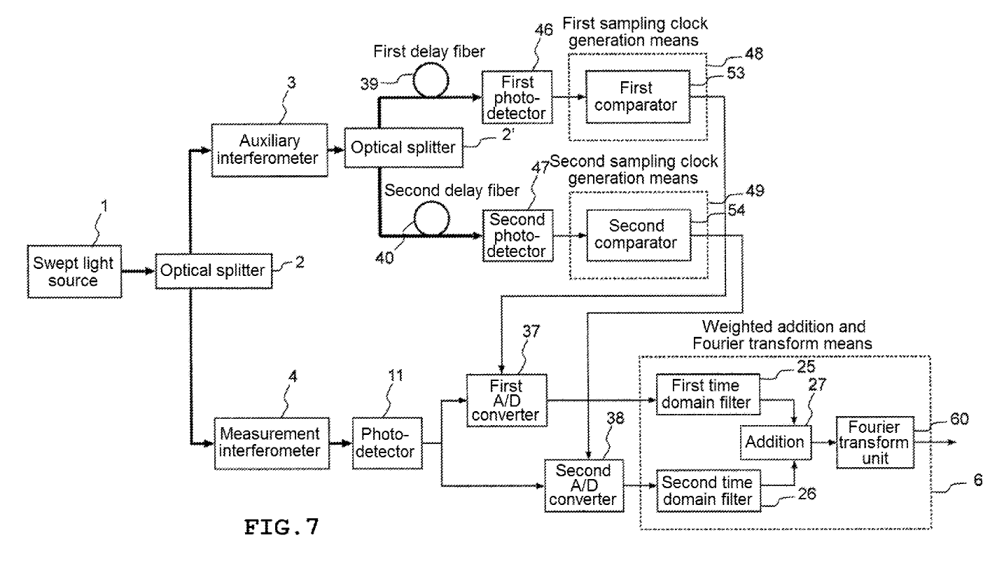

A third embodiment of the invention will be described with reference to FIG. 7. A swept light source 1, an optical splitter 2, an auxiliary interferometer 3, a measurement interferometer 4, a photodetector 11, A/D converters 37 and 38, weighted addition and Fourier transform means 6 have the same structure as those in the second embodiment. An optical splitter 2′ splits light output from the auxiliary interferometer 3 into two light components. One of the two light components is input to a first delay fiber 39 and the other light component is input to a second delay fiber 40.

The first delay fiber 39 and the second delay fiber 40 have different lengths. A first photodetector 46 and a second photodetector 47 converts light components output from the first delay fiber 39 and the second delay fiber into electric signals, respectively. First sampling clock generation means 48 that functions as a first sampling clock generation unit and second sampling clock generation means 49 that functions as a second sampling clock generation unit convert the electric signals into a first sampling clock and a second sampling clock, respectively. The first sampling clock and the second sampling clock are input as sampling clocks to the first A/D converter 37 and the second A/D converter 38, respectively.

The first sampling clock generation means 48 and the second sampling clock generation means 49 include, for example, a first comparator 53 and a second comparator 54, respectively. In a case in which a sinusoidal signal can be input as the sampling clock of the A/D converter, the first comparator 53 and the second comparator 54 may not be provided. The first sampling clock generation means 48 and the second sampling clock generation means 49 may also be used as the frequency conversion means 30 and 30′, such as frequency dividers or PLLs, respectively, as illustrated in FIGS. 15B and 15C.

In the first delay fiber 39 and the second delay fiber 40, it is difficult to add a negative delay time. In a case in which it is necessary to add the negative delay time, a delay fiber or a delay line may be added to the measurement interferometer side such that the delay time on the auxiliary interferometer side is positive. Components after the first A/D converter 37 and the second A/D converter 38 have the same structure as those in the second embodiment.

As described above, in the embodiment illustrated in FIG. 7, only the photodetector 11 to which output light from the measurement interferometer 4 is input is shared by the first linearization means 51 functioning as the first linearization unit and the second linearization means 52 functioning as the second linearization unit. This embodiment has the special feature that the delay fibers 39 and 40 according to the third embodiment can achieve a longer delay time than the electric signal delayers 35 and 36 according to the second embodiment with low loss.

### Fourth Embodiment

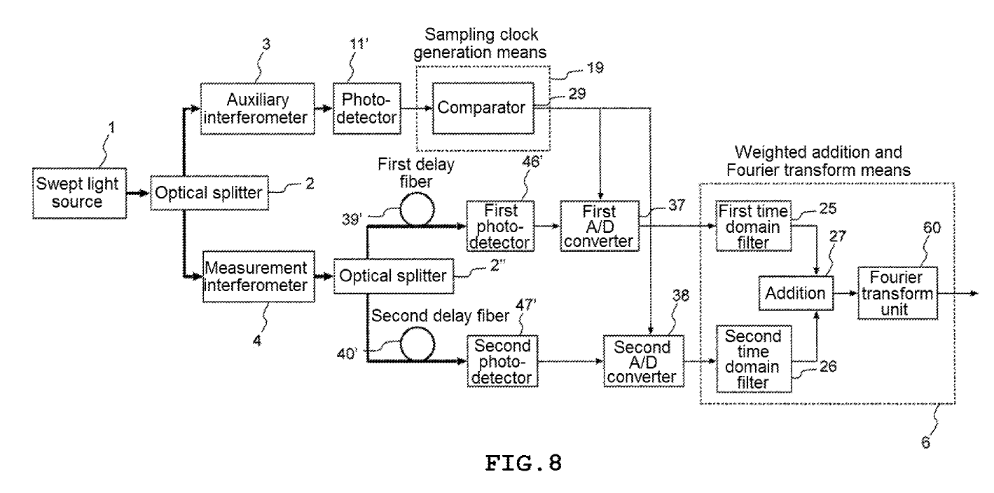

A fourth embodiment of the invention will be described with reference to FIG. 8. In the fourth embodiment, the first delay fiber 39′ and the second delay fiber 40′ according to the third embodiment are inserted on the measurement interferometer side and a swept light source 1, an optical splitter 2, an auxiliary interferometer 3, a measurement interferometer 4, and weighted addition and Fourier transform means 6 have the same structure as those in the third embodiment. Similarly to the second embodiment, a photodetector 11′ converts light output from the auxiliary interferometer 3 into an electric signal and the electric signal is input to a comparator 29 and is converted into a sampling clock.

Sampling clock generation means 19 may also be used as the frequency conversion means 30 and 30′, such as frequency divider or PLL, respectively, as illustrated in FIGS. 15B and 15C. An optical splitter 2″ splits light output from the measurement interferometer 4 into two light components. One of the two light components is input to a first photodetector 46′ through a first delay fiber 39′ and is then converted into a first electric signal. The first electric signal is input to a first A/D converter 37 and is then converted into a first digital signal according to the sampling clock.

The other light component split by the optical splitter 2″ is input to a second photodetector 47′ through a second delay fiber 40′ and is then converted into a second electric signal. The second electric signal is input to a second A/D converter 38 and is then converted into a second digital signal according to the sampling clock. The first delay fiber 39′ and the second delay fiber 40′ have different lengths. In a case in which a sinusoidal signal can be input as the sampling clock of the A/D converter, the comparator 29 may not be provided.

In the first delay fiber 39′ and the second delay fiber 40′, it is difficult to add a negative delay time. In a case in which it is necessary to add the negative delay time, a delay fiber or a delay line may be added to the measurement interferometer side such that the delay time on the auxiliary interferometer side is positive. Components after the first A/D converter 37 and the second A/D converter 38 have the same structure as those in the second embodiment.

As described above, in the embodiment illustrated in FIG. 8, the photodetector 11′ and the sampling clock generation means 19 to which light output from the auxiliary interferometer 3 is input are shared by the first linearization means 51 and the second linearization means 52. Therefore, this embodiment has the special feature that the delay fibers 39′ and 40′ according to the fourth embodiment can achieve a longer delay time than the electric signal delayers 35 and 36 according to the second embodiment with low loss.

### Fifth Embodiment

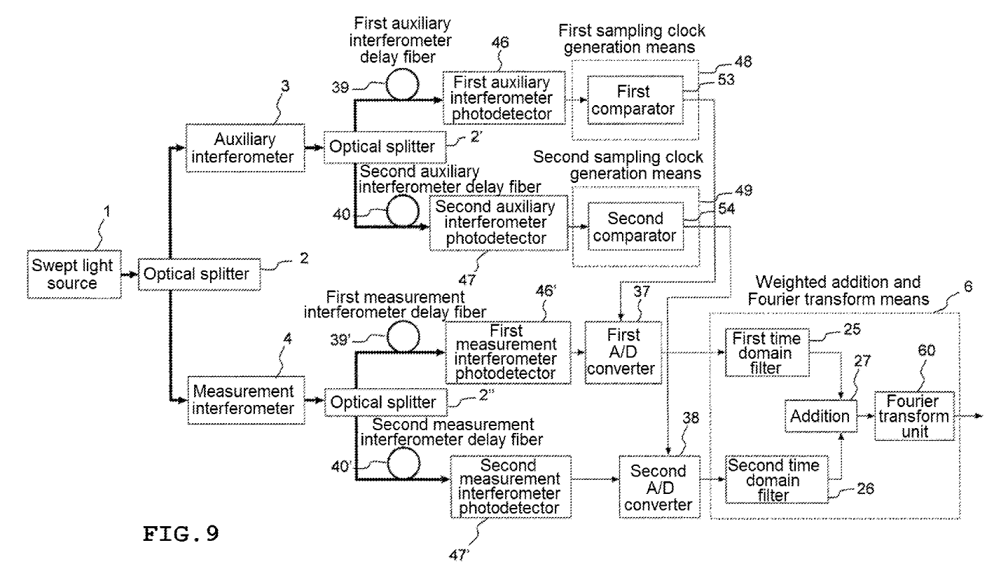

A fifth embodiment of the invention will be described with reference to FIG. 9. In the fifth embodiment, a first delay fiber and a second delay fiber are inserted into on both the auxiliary interferometer side and the measurement interferometer side and a swept light source 1, an optical splitter 2, an auxiliary interferometer 3, a measurement interferometer 4, and weighted addition and Fourier transform means 6 have the same structure as those in the fourth embodiment. Similarly to the third embodiment, an optical splitter 2′ splits light output from the auxiliary interferometer 3 into two light components. One of the two light components is input to a first auxiliary interferometer delay fiber 39 and the other light component is input to a second auxiliary interferometer delay fiber 40.

A first auxiliary interferometer photodetector 46 and a second auxiliary interferometer photodetector 47 convert light components output from the first auxiliary interferometer delay fiber 39 and the second auxiliary interferometer delay fiber 40 into electric signals, respectively. First sampling clock generation means 48 and second sampling clock generation means 49 convert the electric signals into a first sampling clock and a second sampling clock, respectively. The first sampling clock and the second sampling clock are input as sampling clocks to a first A/D converter 37 and a second A/D converter 38, respectively.

An optical splitter 2″ splits light output from the measurement interferometer 4 into two light components. One of the two light components is input to a first measurement interferometer photodetector 46′ through a first measurement interferometer delay fiber 39′ and is then converted into a first electric signal. The first electric signal is input to the first A/D converter 37 and is then converted into a first digital signal according to the first sampling clock.

The other light component split by the optical splitter 2″ is input to second measurement interferometer photodetector 47′ through a second measurement interferometer delay fiber 40′ and is then converted into a second electric signal. The second electric signal is input to the second A/D converter 38 and is then converted into a second digital signal according to the second sampling clock. A difference in length between the first auxiliary interferometer delay fiber 39 and the first measurement interferometer delay fiber 39′ is set so as to be different from a difference in length between the second auxiliary interferometer delay fiber 40 and the second measurement interferometer delay fiber 40′.

Any of the positive and negative delay time differences can be set according to the magnitude relationship between the lengths of the auxiliary interferometer delay fibers 39 and 40 and the measurement interferometer delay fibers 39′ and 40′. Components after the first A/D converter 37 and the second A/D converter 38 have the same structure as those in the fourth embodiment. As described above, in the embodiment illustrated in FIG. 9, two systems of the auxiliary interferometer photodetectors 46 and 47, the sampling clock generation means 48 and 49, the measurement interferometer photodetectors 46′ and 47′, and the A/D converters 37 and are prepared, without being shared by the first linearization means 51 and the second linearization means 52. Therefore, hardware has the largest size.

The setting of the delay time will be described in detail below. It is assumed that the fiber lengths (round-trip fiber lengths in the case of a reflective type) of two optical paths in the auxiliary interferometer are Lₐ and L_{b}, the fiber length (a round-trip fiber length in the case of the reflective type) of the optical path of the reference light in the measurement interferometer is Lᵣ, and a position on a measurement target optical fiber where the fiber length of the optical path reflected at the measurement target optical fiber in the measurement interferometer is equal to the fiber length Lᵣ of the optical path of the reference light is z=0. In addition, it is assumed that the other delay time of the auxiliary interferometer is equal to the other delay time of the measurement interferometer.

The fiber length of the optical path of light reflected at the position z on the measurement target optical fiber is 2z+Lᵣ. Therefore, the delay time t_{ab} of a beat signal in the auxiliary interferometer, the delay time t₁ᵣ of a beat signal generated by the reference light and light reflected at a position z₁ on the measurement target optical fiber in the measurement interferometer, and the delay time t₂ᵣ of a beat signal generated by the reference light and light reflected at a position z₂ on the measurement target optical fiber in the measurement interferometer are represented by the following Equations 4 to 6, respectively.

$$\begin{matrix}{t}_{ab} = \frac{n ( {L}_{a} + {L}_{b} )}{2 c} & ( 4 ) \\ {t}_{1 r} = \frac{n ( 2 {z}_{1} + {L}_{r} + {L}_{r} )}{2 c} = \frac{n ( {z}_{1} + {L}_{r} )}{c} & ( 5 ) \\ {t}_{2 r} = \frac{n ( 2 {z}_{2} + {L}_{r} + {L}_{r} )}{2 c} = \frac{n ( {z}_{2} + {L}_{r} )}{c} & ( 6 )\end{matrix}$$

Here, n is the refractive index of an optical fiber and c is the speed of light. A first delay time δt₁ and a second delay time δt₂ which are added to the auxiliary interferometer such that an error caused by non-linear sweep is zero at the positions z₁ and z₂ on the measurement target optical fiber are represented by Equations 7 to 10. In addition, in a case in which the delay times are added to the measurement interferometer, the signs are reversed.

$$\begin{matrix}δ {t}_{1} = {t}_{1 r} - {t}_{ab} & ( 7 ) \\ = \frac{n}{c} ( {z}_{1} + {L}_{r} - \frac{{L}_{a} + {L}_{b}}{2} ) & ( 8 ) \\ δ {t}_{2} = {t}_{2 r} - {t}_{ab} & ( 9 ) \\ = \frac{n}{c} ( {z}_{2} + {L}_{r} - \frac{{L}_{a} + {L}_{b}}{2} ) & ( 10 )\end{matrix}$$

Next, the setting of weights will be described in detail. An error term ψ₁ after first linearization and an error term ψ₂ after second linearization which are generated by non-linear sweep are represented by Equations 11 and 12, respectively.

ψ₁(z)∝z·(z−z₁) (11)

ψ₂(z)∝z·(z−z₂) (12)

Here, z is a distance on the measurement target optical fiber. It is assumed that a first linearization delay time is set such that an error caused by non-linear sweep is zero at a distance z₁ on the measurement target optical fiber and a second linearization delay time is set such that an error caused by non-linear sweep is zero at a distance z₂ on the measurement target optical fiber. Here, as illustrated in Equations 13 and 14, the signal after first linearization is multiplied by a weight of r₁(z) and the signal after second linearization is multiplied by a weight of r₂(z). Then, the weighted signals are added such that an error term is zero. When the weights r₁(z) and r₂(z) are calculated, Equations 15 and 16 are obtained.

$$\begin{matrix}{r}_{1} ( z ) \cdot {ψ}_{1} ( z ) + {r}_{2} ( z ) \cdot {ψ}_{2} ( z ) = 0 & ( 13 ) \\ {r}_{1} ( z ) + {r}_{2} ( z ) = 1 & ( 14 ) \\ {r}_{1} ( z ) = \frac{- {ψ}_{2} ( z )}{{ψ}_{1} ( z ) - {ψ}_{2} ( z )} = \frac{{z}_{2} - z}{{z}_{2} - {z}_{1}} & ( 15 ) \\ {r}_{2} ( z ) = \frac{{ψ}_{1} ( z )}{{ψ}_{1} ( z ) - {ψ}_{2} ( z )} = \frac{z - {z}_{1}}{{z}_{2} - {z}_{1}} & ( 16 )\end{matrix}$$

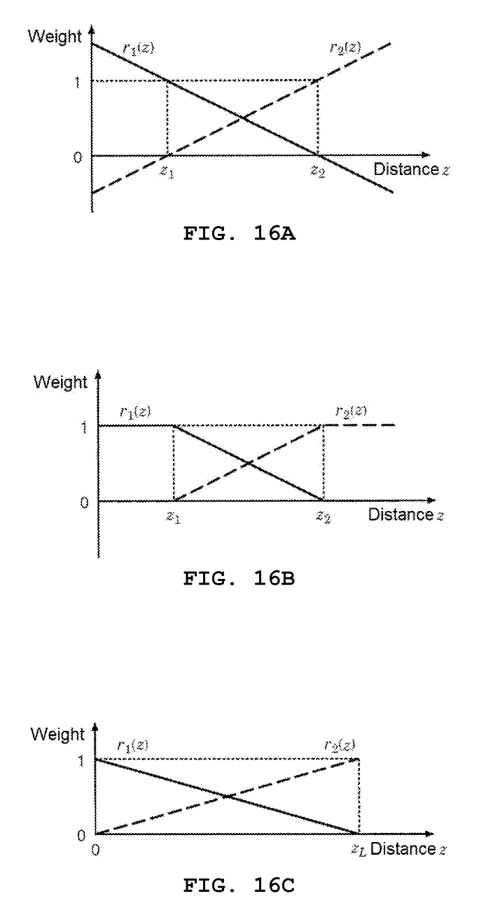

The weights r₁(z) and r₂(z) are as illustrated in FIG. 16A. In the domains in which z<z₁ or z>z₂ are satisfied, since the signs of r₁(z) and r₂(z) are different from each other, the influence of noise is not increased by addition, but is increased by subtraction. Therefore, it is possible to limit the minimum values of r₁(z) and r₂(z) to 0, as illustrated in FIG. 16B. In this case, in a domain in which z₁≦z≦z₂ is satisfied, a non-linear error is zero. In a domain in which z<z₁ is satisfied, the signal is the same as the signal after first linearization. In a domain in which z>z₂ is satisfied, the signal is the same as the signal after second linearization. When z₁ is set to zero and z₂ is set to a measurement target optical fiber length z_{L}, the weights are always positive values as illustrated in FIG. 16C.

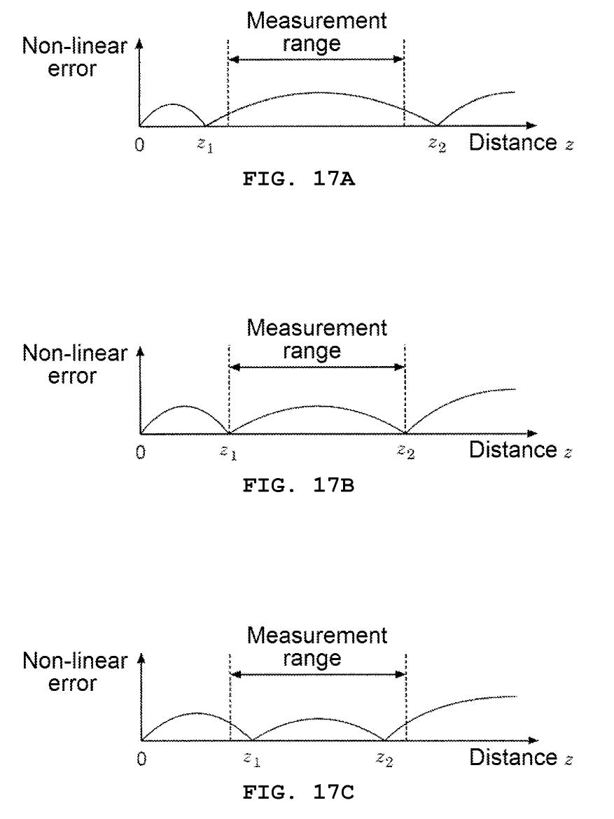

This method is designed such that a non-linear error is zero in the domain in which z₁≦z≦z₂ is satisfied. Therefore, as illustrated in FIG. 17A, z₁ and z₂ may be arranged beyond the measurement range of the measurement target optical fiber. However, in this case, a higher-order non-linear error is likely to remain. It is preferable that z₁ and z₂ are arranged at both ends of the measurement range of the measurement target optical fiber in order to reduce, for example, a higher-order non-linear error, as illustrated in FIG. 17B. In addition, z₁ and z₂ may be arranged inside both ends of the measurement range of the measurement target optical fiber to reduce the maximum value of, for example, a higher-order non-linear error, as illustrated in FIG. 17C.

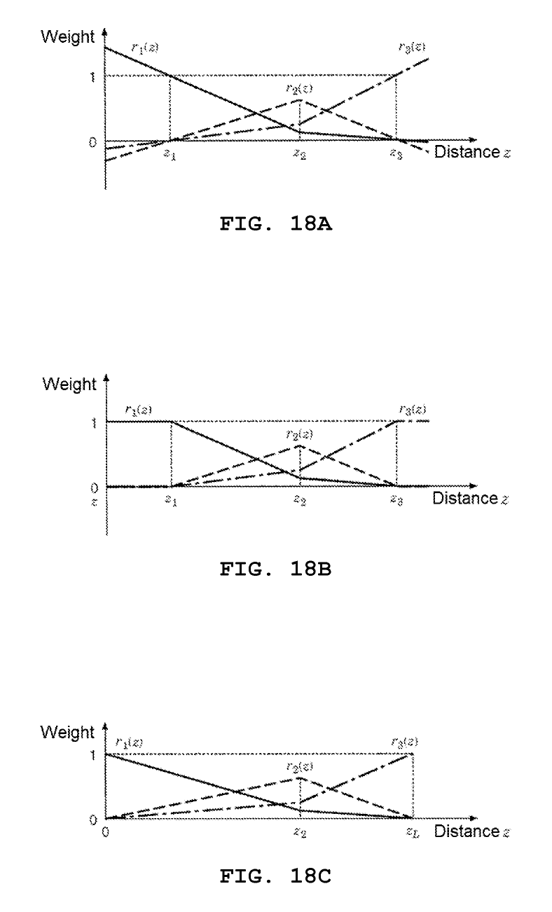

In a case in which three systems of linearization means are provided, there are two conditional equations and three variables. Therefore, weights are not uniquely determined and various weights may be given. For example, weights r₁(z), r₂(z), and r₃(z) can be set as illustrated in FIG. 18A. Even in the case of three systems, the minimum value of the weight can be limited to zero, as illustrated in FIG. 18B. In addition, z₁ can be set to zero and z₃ can be set to the same value as the measurement target optical fiber length z₁, as illustrated in FIG. 18C.

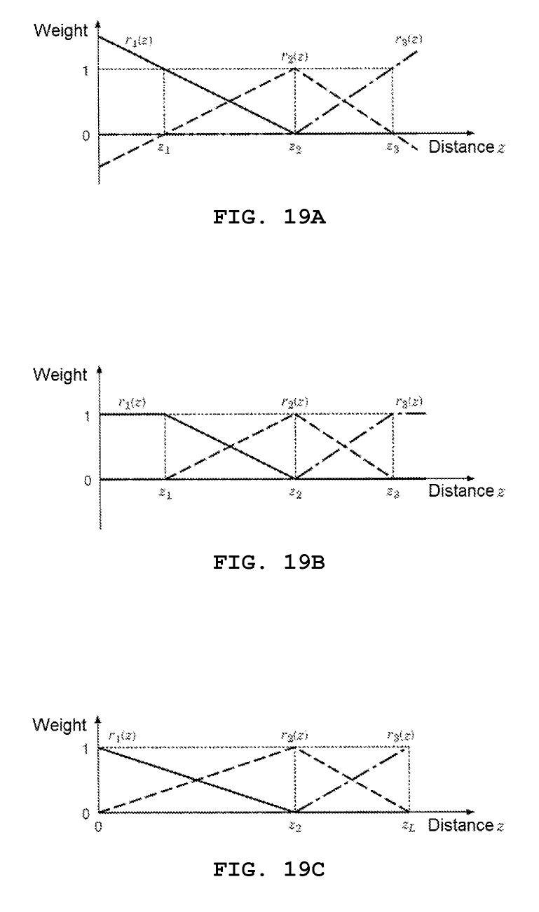

However, it is preferable that the distance range in which the output of one linearization means is used is close to a point where an error caused by non-linear sweep is zero. For example, it is preferable that the output of the first linearization means is used in the vicinity of the distance z₁. When r₁ (z) is 0 in the domain in which z≧z₂ is satisfied, r₃(z) is 0 in the domain in which z≦z₂ is satisfied, the output of the first linearization means is used only in the domain in which z<z₂ is satisfied, and the output of the third linearization means is used only in the domain in which z>z₂ is satisfied, the weights r₁(z), r₂(z), and r₃(z) are as illustrated in FIG. 19A.

It is preferable that z₂ is set at the midpoint (z₁+z₃)/2 between z₁ and z₃. However, in this case, as the distance from z=0 increases, a higher-order non-linear error increases. Therefore, as illustrated in FIG. 18A and FIG. 19A, z₂>(z₁+z₃)/2 may be set so as to minimize a higher-order non-linear error at a long distance.

Even in this case, it is possible to limit the minimum value of r₂(z) to zero, as illustrated in FIG. 19B. In addition, z1 can be set to zero and z₃ can be set to the same value as the measurement target optical fiber length z_{L}, as illustrated in FIG. 19C. Similarly to the case of two systems, z₁ and z₃ may be arranged beyond the measurement range of the measurement target optical fiber. It is preferable that z₁ and z₃ are arranged at both ends of the measurement range of the measurement target optical fiber. In addition, z₁ and z₃ may be arranged inside both ends of the measurement range of the measurement target optical fiber. In this case, similarly, the embodiment can be extended to a case in which a plurality of systems are provided.

### INDUSTRIAL APPLICABILITY

The invention can be applied to a device that measures the strain, temperature, position, or shape of an object, to which the measurement target optical fiber is fixed, as a measurement target from the information of the measurement target optical fiber obtained by the device according to the embodiment. In this case, examples of the measurement target to which the measurement target optical fiber is fixed can include a medical catheter, a medical inspection probe, a medical sensor, a building inspection sensor, a submarine sensor, and a geological sensor.

### DESCRIPTION OF REFERENCE NUMERALS AND SIGNS

1: Swept light source

2, 2′, 2″: Optical splitter

3: Auxiliary interferometer

4: Measurement interferometer

5: Linearization means

6: Weighted addition and Fourier transform means

11, 11′: Photodetector

12, 12′: A/D converter

13: Sampling time calculation means

14: Delay time

15: Sampling means

17: Instantaneous phase calculation unit

18: Time calculation unit

19: Sampling clock generation means

21: First delay time

22: Second delay time

23: First re-sampling unit

24: Second re-sampling unit

25: First time domain filter

26: Second time domain filter

27: Addition

29: Comparator

30, 30′: Frequency conversion means

31a, 31b, 34a, 41a, 41b, 41c, 42b, 45a, 45b: Optical coupler

32a, 32b: Delay fiber

33a, 33b, 44a, 44b, 44c: Polarization controller

35: First delayer

35a, 36a: Mirror

35b, 36b: Faraday mirror

36: Second delayer

37: First A/D converter

38: Second A/D converter

39, 39′: First delay fiber

40, 40′: Second delay fiber

42a: Optical circulator

43a: Measurement target optical fiber

46, 46′: First photodetector

47, 47′: Second photodetector

47a: Polarizing beam splitter

48: First sampling clock generation means

49: Second sampling clock generation means

51: First linearization means

52: Second linearization means

53: First comparator

54: Second comparator

60: Fourier transform unit

62: Hilbert transform

63: Phase calculation

64: Delay

65: FIR filter

66: Arctangent function

67: Complex coefficient FIR filter

68: Zero cross time calculation

71: First delay time adjustment

72: Second delay time adjustment

73: First weighting filter

74: Second weighting filter

75: First Fourier transform

76: Second Fourier transform

77: First frequency domain filter

78: Second frequency domain filter

79: First delay time adjustment

80: Second delay time adjustment

81: First weight multiplication

82: Second weight multiplication

83: Addition

What is claimed is:

1. An optical frequency domain reflectometer comprising:
a swept light source that outputs wavelength-swept light as output light;
an auxiliary interferometer that inputs a portion of the output light from the swept light source to an auxiliary interference signal generating delay fiber, makes light output from the auxiliary interference signal generating delay fiber and another portion of the output light from the swept light source interfere with each other, and outputs an auxiliary interference signal;
a measurement interferometer that inputs a portion of the output light from the swept light source to a measurement target optical fiber, makes light reflected from the measurement target optical fiber and another portion of the output light from the swept light source interfere with each other, and outputs a measurement interference signal;
a plurality of linearization units that have different delay times, compensate non-linearity in a wavelength sweep of the swept light source for the measurement interference signal, using the auxiliary interference signal, and output compensated signals as output signals; and
a weighted addition and Fourier transform unit that outputs a frequency domain signal as a result of addition and Fourier transformation of weighted signals which are multiplying the output signals from the plurality of linearization units by different weights.

2. The optical frequency domain reflectometer according to claim 1,
wherein the weights of the weighted addition and Fourier transform unit have, as a weighting characteristics, a characteristics that linearly change with respect to position on the measurement target optical fiber among each positions on the measurement target optical fiber which correspond to each of the delay times of the plurality of linearization units and where an error caused by the non-linearity in the wavelength sweep of the swept light source is a minimum.

3. The optical frequency domain reflectometer according to claim 2,
wherein the plurality of linearization units are a first linearization unit and a second linearization unit that have different delay times, and
the weighted addition and Fourier transform unit outputs a frequency domain signal as a result of addition and Fourier transformation of weighted signals which are multiplying an output signal from the first linearization unit and an output signal from the second linearization unit by different weights.

4. The optical frequency domain reflectometer according to claim 3, further comprising:
a photodetector that converts the auxiliary interference signal from the auxiliary interferometer into an auxiliary electric signal;
an A/D converter that converts the auxiliary electric signal into an auxiliary digital signal at a constant sampling frequency;
a sampling time calculation unit that calculates a sampling time when a phase of the auxiliary digital signal is a regular interval;
a photodetector that converts the measurement interference signal from the measurement interferometer into a measurement electric signal; and
an A/D converter that converts the measurement electric signal into a measurement digital signal at a constant sampling frequency,
wherein the first linearization unit includes a first delay time addition unit that adds a first delay time to the sampling time to calculate a first sampling time and a first re-sampling unit that re-samples the measurement digital signal according to the first sampling time and outputs a first measurement digital signal,
the second linearization unit includes a second delay time addition unit that adds a second delay time to the sampling time to calculate a second sampling time and a second re-sampling unit that re-samples the measurement digital signal according to the second sampling time and outputs a second measurement digital signal,
an output signal from the first linearization unit is the first measurement digital signal, and
an output signal from the second linearization unit is the second measurement digital signal.

5. The optical frequency domain reflectometer according to claim 3, further comprising:
a photodetector that converts the auxiliary interference signal from the auxiliary interferometer into an auxiliary electric signal;
a sampling clock generation unit that generates a sampling clock with a frequency which is proportional to a frequency of the auxiliary electric signal; and
a photodetector that converts the measurement interference signal from the measurement interferometer into a measurement electric signal,
wherein the first linearization unit includes a first delayer that adds a first delay time to the sampling clock and outputs a first sampling clock and a first A/D converter that converts the measurement electric signal into a first measurement digital signal according to the first sampling clock,
the second linearization unit includes a second delayer that adds a second delay time to the sampling clock and outputs a second sampling clock and a second A/D converter that converts the measurement electric signal into a second measurement digital signal according to the second sampling clock,
an output signal from the first linearization unit is the first measurement digital signal, and
an output signal from the second linearization unit is the second measurement digital signal.

6. The optical frequency domain reflectometer according to claim 3, further comprising:
a photodetector that converts the measurement interference signal from the measurement interferometer into a measurement electric signal,
wherein the first linearization unit includes:
a first delay fiber that adds a first delay time to the auxiliary interference signal from the auxiliary interferometer;
a first photodetector that converts output light from the first delay fiber into a first auxiliary electric signal;
a first sampling clock generation unit that generates a first sampling clock from the first auxiliary electric signal; and
a first A/D converter that converts the measurement electric signal into a first measurement digital signal according to the first sampling clock,
the second linearization unit includes:
a second delay fiber that adds a second delay time to the auxiliary interference signal from the auxiliary interferometer;
a second photodetector that converts output light from the second delay fiber into a second auxiliary electric signal;
a second sampling clock generation unit that generates a second sampling clock from the second auxiliary electric signal; and
a second A/D converter that converts the measurement electric signal into a second measurement digital signal according to the second sampling clock,
an output signal from the first linearization unit is the first measurement digital signal, and
an output signal from the second linearization unit is the second measurement digital signal.

7. The optical frequency domain reflectometer according to claim 3, further comprising:
a photodetector that converts the auxiliary interference signal from the auxiliary interferometer into an auxiliary electric signal; and
a sampling clock generation unit that generates a sampling clock with a frequency which is proportional to a frequency of the auxiliary electric signal,
wherein the first linearization unit includes:
a first delay fiber that adds a first delay time to the measurement interference signal from the measurement interferometer;
a first photodetector that converts output light from the first delay fiber into a first measurement electric signal; and
a first A/D converter that converts the first measurement electric signal into a first measurement digital signal according to the sampling clock,
the second linearization unit includes:
a second delay fiber that adds a second delay time to the measurement interference signal from the measurement interferometer;
a second photodetector that converts output light from the second delay fiber into a second measurement electric signal; and
a second A/D converter that converts the second measurement electric signal into a second measurement digital signal according to the sampling clock,
an output signal from the first linearization unit is the first measurement digital signal, and
an output signal from the second linearization unit is the second measurement digital signal.

8. The optical frequency domain reflectometer according to claim 4,
wherein the sampling time calculation unit includes:
a digital filter that converts the auxiliary digital signal into a complex digital signal;
a phase calculation unit that calculates a phase of the complex digital signal; and
a time calculation unit that calculates a time when the phase is a regular interval.

9. The optical frequency domain reflectometer according to claim 5,
wherein the sampling clock generation unit is a comparator that compares the auxiliary electric signal with a predetermined voltage and outputs the sampling clock.

10. The optical frequency domain reflectometer according to claim 6,
wherein the first sampling clock generation unit is a comparator that compares the first auxiliary electric signal with a predetermined voltage and outputs the first sampling clock, and
the second sampling clock generation unit is a comparator that compares the second auxiliary electric signal with a predetermined voltage and outputs the second sampling clock.

11. The optical frequency domain reflectometer according to claim 4,
wherein the weighted addition and Fourier transform unit includes:
a first time domain filter that applies a first weight characteristic to the first measurement digital signal and performs first delay time adjustment;
a second time domain filter that applies a second weight characteristic to the second measurement digital signal and performs second delay time adjustment;
an adder that adds an output from the first time domain filter and an output from the second time domain filter; and
a Fourier transform unit that performs Fourier transform for an output from the adder.

12. The optical frequency domain reflectometer according to claim 4,
wherein the weighted addition and Fourier transform unit includes:
a first Fourier transform unit that performs Fourier transform for the first measurement digital signal;
a second Fourier transform unit that performs Fourier transform for the second measurement digital signal;
a first frequency domain filter that applies a first weight characteristic to an output signal from the first Fourier transform unit and performs first delay time adjustment;
a second frequency domain filter that applies a second weight characteristic to an output signal from the second Fourier transform unit and performs second delay time adjustment; and
an adder that adds an output signal from the first frequency domain filter and an output signal from the second frequency domain filter.

13. The optical frequency domain reflectometer according to claim 1,
wherein the plurality of linearization units are a first linearization unit and a second linearization unit that have different delay times, and
the weighted addition and Fourier transform unit outputs a frequency domain signal as a result of addition and Fourier transformation of weighted signals which are multiplying an output signal from the first linearization unit and an output signal from the second linearization unit by different weights.

14. The optical frequency domain reflectometer according to claim 7,
wherein the sampling clock generation unit is a comparator that compares the auxiliary electric signal with a predetermined voltage and outputs the sampling clock.

15. The optical frequency domain reflectometer according to claim 13, further comprising:
a photodetector that converts the auxiliary interference signal from the auxiliary interferometer into an auxiliary electric signal;
an A/D converter that converts the auxiliary electric signal into an auxiliary digital signal at a constant sampling frequency;
a sampling time calculation unit that calculates a sampling time when a phase of the auxiliary digital signal is a regular interval;
a photodetector that converts the measurement interference signal from the measurement interferometer into a measurement electric signal; and
an A/D converter that converts the measurement electric signal into a measurement digital signal at a constant sampling frequency,
wherein the first linearization unit includes a first delay time addition unit that adds a first delay time to the sampling time to calculate a first sampling time and a first re-sampling unit that re-samples the measurement digital signal according to the first sampling time and outputs a first measurement digital signal,
the second linearization unit includes a second delay time addition unit that adds a second delay time to the sampling time to calculate a second sampling time and a second re-sampling unit that re-samples the measurement digital signal according to the second sampling time and outputs a second measurement digital signal,
an output signal from the first linearization unit is the first measurement digital signal, and
an output signal from the second linearization unit is the second measurement digital signal.

16. The optical frequency domain reflectometer according to claim 13, further comprising:
a photodetector that converts the auxiliary interference signal from the auxiliary interferometer into an auxiliary electric signal;
a sampling clock generation unit that generates a sampling clock with a frequency which is proportional to a frequency of the auxiliary electric signal; and
a photodetector that converts the measurement interference signal from the measurement interferometer into a measurement electric signal,
wherein the first linearization unit includes a first delayer that adds a first delay time to the sampling clock and outputs a first sampling clock and a first A/D converter that converts the measurement electric signal into a first measurement digital signal according to the first sampling clock,
the second linearization unit includes a second delayer that adds a second delay time to the sampling clock and outputs a second sampling clock and a second A/D converter that converts the measurement electric signal into a second measurement digital signal according to the second sampling clock,
an output signal from the first linearization unit is the first measurement digital signal, and
an output signal from the second linearization unit is the second measurement digital signal.

17. The optical frequency domain reflectometer according to claim 13, further comprising:
a photodetector that converts the measurement interference signal from the measurement interferometer into a measurement electric signal
wherein the first linearization unit includes:
a first delay fiber that adds a first delay time to the auxiliary interference signal from the auxiliary interferometer;
a first photodetector that converts output light from the first delay fiber into a first auxiliary electric signal;
a first sampling clock generation unit that generates a first sampling clock from the first auxiliary electric signal; and
a first A/D converter that converts the measurement electric signal into a first measurement digital signal according to the first sampling clock,
the second linearization unit includes:
a second delay fiber that adds a second delay time to the auxiliary interference signal from the auxiliary interferometer;
a second photodetector that converts output light from the second delay fiber into a second auxiliary electric signal;
a second sampling clock generation unit that generates a second sampling clock from the second auxiliary electric signal; and
a second A/D converter that converts the measurement electric signal into a second measurement digital signal according to the second sampling clock,
an output signal from the first linearization unit is the first measurement digital signal, and
an output signal from the second linearization unit is the second measurement digital signal.

18. The optical frequency domain reflectometer according to claim 13, further comprising:
a photodetector that converts the auxiliary interference signal from the auxiliary interferometer into an auxiliary electric signal; and
a sampling clock generation unit that generates a sampling clock with a frequency which is proportional to a frequency of the auxiliary electric signal,
wherein the first linearization unit includes:
a first delay fiber that adds a first delay time to output light from the measurement interferometer;
a first photodetector that converts output light from the first delay fiber into a first measurement electric signal; and
a first A/D converter that converts the first measurement electric signal into a first measurement digital signal according to the sampling clock,
the second linearization unit includes:
a second delay fiber that adds a second delay time to the output light from the measurement interferometer;
a second photodetector that converts output light from the second delay fiber into a second measurement electric signal; and
a second A/D converter that converts the second measurement electric signal into a second measurement digital signal according to the sampling clock,
an output signal from the first linearization unit is the first measurement digital signal, and
an output signal from the second linearization unit is the second measurement digital signal.

19. The optical frequency domain reflectometer according to claim 15,
wherein the sampling time calculation unit includes:
a digital filter that converts the auxiliary digital signal into a complex digital signal;
a phase calculation unit that calculates a phase of the complex digital signal; and
a time calculation unit that calculates a time when the phase is a regular interval.

20. An optical frequency domain reflectometry method that inputs wavelength-swept light to an auxiliary interferometer and a measurement interferometer including a measurement target optical fiber, performs a linearization process of compensating non-linearity in a wavelength sweep for an output signal from the measurement interferometer, using an output signal from the auxiliary interferometer, performs Fourier transform for a result of the linearization process, and outputs a frequency domain signal, the optical frequency domain reflectometry comprising;
performing a plurality of linearization processes with different delay times;
weighting signals subjected to the plurality of linearization processes;
adding results of the weighting;
performing Fourier transform for result of the adding; and
outputting result of the Fourier transform as the frequency domain signal.
